(19) United States
(12) Patent Application Publication
(10) Pub. No.: US 2023/0161405 A1
(43) Pub. Date: May 25, 2023

(54) EYE TRACKING DEVICE AND EYE TRACKING METHOD

(71) Applicant: Quanta Computer Inc., Taoyuan City (TW)

(72) Inventors: Tsung-Li TSAI, Taoyuan City (TW); Chun-Lung CHEN, Taoyuan City (TW); Chun-Nan HUANG, Taoyuan City (TW); Bing-Kai HUANG, Taoyuan City (TW); Jia-Cheng CHANG, Taoyuan City (TW)

(21) Appl. No.: 17/686,789

(22) Filed: Mar. 4, 2022

(30) Foreign Application Priority Data
Nov. 24, 2021 (TW) 110143640

(51) Int. Cl. G06F 3/01; G02B 27/00

(52) U.S. Cl. CPC G06F 3/013; G02B 27/0093

(57) ABSTRACT

An eye tracking device is provided. The eye tracking device includes an optical element, an emitting element, and an image capturing element. The optical element corresponds to an eye. The optical element includes a characteristic pattern. The emitting element is disposed close to the optical element. The emitting element provides a light signal to the optical element, so that the characteristic pattern is shown in the eye. The image capturing element is disposed close to the eye. The image capturing element captures an image of the eye.

### CROSS REFERENCE TO RELATED APPLICATIONS

This application claims the benefit of Taiwan Patent Application No. 110143640, filed Nov. 24, 2021, the entirety of which is incorporated by reference herein.

### BACKGROUND OF THE INVENTION

### Field of the Invention

The present invention relates to an eye tracking device and an eye tracking method.

### Description of the Related Art

As technology has developed, eye tracking devices and eye tracking methods have wider application. For example, advertising producers may determine the most effective parts of an advertisement based on how long consumers focus on the advertisement. For example, a user may control a device using the movement of his eye. For example, head-mounted displays (HMDs) have become popular, especially HMDs with virtually reality (VR) techniques, augmented reality (AR) techniques, and the like. If a HMD is able to track the eyes of the user, it may further improve user experience.

Traditionally, eye tracking devices and eye tracking methods provide light directly to the eye via multiple emitting elements (such as light sources) to generate a characteristic pattern for identifying the position of the eye. However, these emitting elements need to be placed on a circuit element and thus occupy a larger space. In addition, a reflective element (such as a hot mirror) with a relatively large volume may be required to reflect the characteristic pattern in the eye. Therefore, the traditional eye tracking devices and eye tracking methods are disadvantageous for both cost reduction and miniaturization for HMDs.

### BRIEF SUMMARY OF THE INVENTION

According to some embodiments, an eye tracking device is provided. The eye tracking device includes an optical element, an emitting element, and an image capturing element. The optical element corresponds to an eye. The optical element includes a characteristic pattern. The emitting element is disposed close to the optical element. The emitting element provides a light signal to the optical element, so that the characteristic pattern is shown in the eye. The image capturing element is disposed close to the eye. The image capturing element captures an image of the eye.

According to some embodiments, an eye tracking method is provided. The method includes generating a light signal using an emitting element. The light signal enters an optical element including a characteristic pattern, so that the characteristic pattern is shown in an eye. The method also includes capturing an image of the eye by an image capturing element and identifying a position of the eye based on the characteristic pattern in the eye by a processing unit or the image capturing element.

### BRIEF DESCRIPTION OF THE DRAWINGS

Aspects of the present disclosure are best understood from the following detailed description when read with the accompanying figures. It should be noted that, in accordance with the standard practice in the industry, various features are not drawn to scale. In fact, the dimensions of the various features may be arbitrarily increased or reduced for clarity of discussion.

FIG. 1 is a schematic view of the eye and the eye tracking device.

FIG. 2 is an exploded view of the eye tracking device.

FIG. 3 to FIG. 6 are schematic views of the optical element with different characteristic patterns.

FIG. 7 is a flow chart of the eye tracking method.

FIG. 8 to FIG. 10 are schematic views of the HMDs that are capable of tracking eyes.

### DETAILED DESCRIPTION OF THE INVENTION

The following disclosure provides many different embodiments, or examples, for implementing different features of the subject matter provided. Specific examples of components and arrangements are described below to simplify this disclosure. These are, of course, merely examples and are not intended to be limiting. For example, the formation of a first feature “on” and/or “above” a second feature in the description that follows may include embodiments in which the first and second features are formed in direct contact, and may also include embodiments in which additional features may be formed between the first and second features, so that the first and second features may not be in direct contact. The spatially relative terms are intended to encompass different orientations of the device in use or operation in addition to the orientation depicted in figures. The apparatus may be otherwise oriented (rotated 90 degrees or at other orientations) and the spatially relative descriptors used herein may likewise be interpreted accordingly. In addition, in different examples of this disclosure, symbols or alphabets may be used repeatedly.

Unless the context requires otherwise, throughout the specification and claims that follow, the word “include”, “have” and variations thereof, such as “includes”, “including”, “having” are to be construed in an open, inclusive sense, that is, as “including, but not limited to.”

In the specification, terms such as “about” in conjunction with a specific value are to be interpreted so as not to exclude insignificant deviation from the specified value and may include deviations of up to, 10%, 5%, 3%, 2%, 1%, 0.5%, etc. Additionally, the term “between a first value and a second value” may be interpreted as include the first value, the second value, and other values between the first value and the second value.

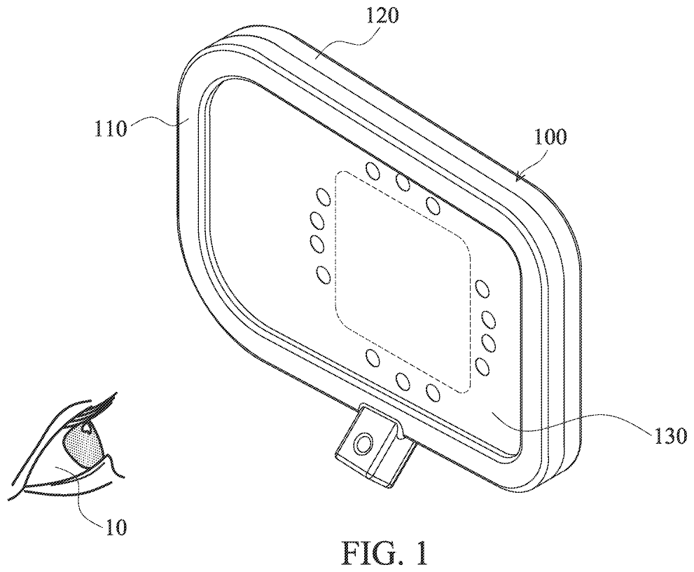

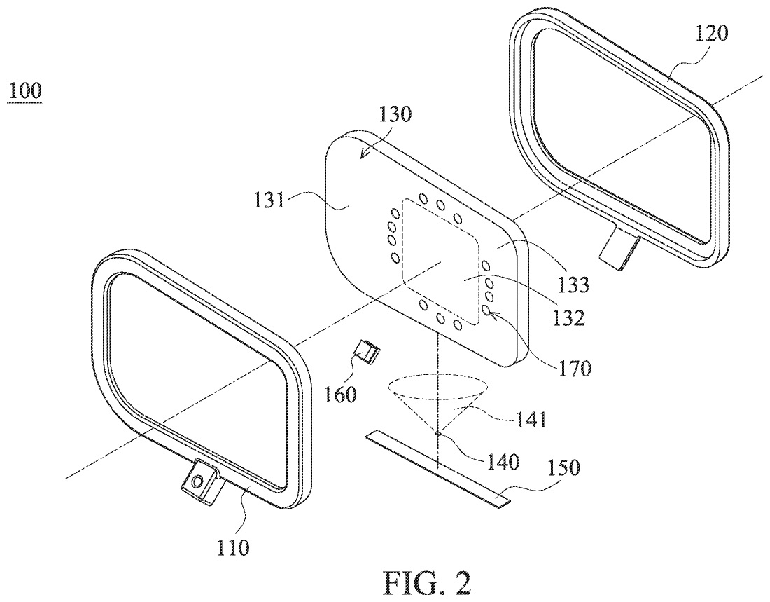

Please refer to FIG. 1 and FIG. 2. FIG. 1 is a schematic view of an eye 10 and an eye tracking device 100. FIG. 2 is an exploded view of the eye tracking device 100. For simplification, only one eye 10 is illustrated in FIG. 1. It should be noted that, the eye tracking device 100 may be used for both eyes.

In this embodiment, the eye tracking device 100 includes a front cover 110, a rear cover 120, an optical element 130, an emitting element 140, a circuit element 150, and an image capturing element 160. It should be noted that, the elements may be added or omitted.

The rear cover 120 may be connected to the front cover 110. In some embodiments, fastening elements (such as screws) or glue may be used to affix the front cover 110 to the rear cover 120. The optical element 130, the emitting element 140, the circuit element 150, and the image capturing element 160 may be disposed between the front cover 110 and the rear cover 120. The front cover 110 and the rear cover 120 may receive and protect the optical element 130, the emitting element 140, the circuit element 150, the image capturing element 160, and the like. In addition, the front cover 110 and the rear cover 120 that are connected to each other may be sealed to prevent dust from entering the front cover 110 and the rear cover 120. Dust may be enlarged due to the optical properties of the optical element 130 and may hinder user experience. Therefore, the front cover 110 and the rear cover 120 are usually made of a material that does not generate dust. For example, the front cover 110 and the rear cover 120 may include a plastic material, but is not limited thereto.

The optical element 130 corresponds to the eye 10. In particular, the eye 10 looks at the display screen through the optical element 130. The optical element 130 may be transparent. The optical element 130 may be a lens, such as a Fresnel lens. The optical element 130 may be made of plastic or glass. When the optical element 130 is made of plastic, the weight is lighter and the cost is lower. When the optical element 130 is made of glass, the optical properties are better. The optical element 130 may have different shapes, such as circular, elliptical, polygonal, etc. In some embodiments, the shape of the optical element 130 depends on the shape of the optical element inside the HMD.

The emitting element 140 is disposed on the circuit element 150, and the emitting element 140 is disposed close to the optical element 130. The emitting element 140 may provide a light signal 141 (or electromagnetic radiation) to the optical element 130. In FIG. 2, the area of the light signal 141 is schematically illustrated with dashed lines. In some embodiments, the light signal 141 provided by the emitting element 140 is an invisible light in order to reduce the disturbance to the user. In some embodiments the light signal 141 provided by the emitting element 140 is an infrared light. For example, the emitting element 140 may be an infrared light emitting diode (IR-LED). An IR-LED may transform the electrical energy into an infrared light signal with a wavelength of 700 nanometer (nm) to 1000 nm. Also, an IR-LED produces less heat and consumes less energy. An IR-LED may include GaAs or GaAlAs, but is not limited thereto.

The circuit element 150 is disposed under the optical element 130. The circuit element 150 may be a circuit board. For example, the circuit element 150 may be a rigid board, a flex board, or a rigid-flex board, but is not limited thereto.

The image capturing element 160 is disposed close to the eye 10. The image capturing element 160 may capture one or more images of the eye 10. The image capturing element 160 may be a charge-coupled device (CCD) or a CMOS image sensor, but is not limited thereto. It should be noted that, in this embodiment, the image capturing element 160 is disposed on the bottom side of the front cover 110 and the rear cover 120. When the user watches the display screen, the disturbance to the user is reduced, because the image capturing element 160 is located lower relative to the eye 10. However, the image capturing element 160 may be placed in other positions. In addition, in this embodiment, the emitting element 140, the circuit element 150, and the image capturing element 160 are disposed on the same side of the front cover 110 and the rear cover 120, so that the space is utilized and miniaturization is achieved.

The optical element 130 includes a characteristic pattern 170. In some embodiments, the characteristic pattern 170 includes a plurality of geometric shapes. In some embodiments, the characteristic pattern 170 may be a plurality of holes. After the light signal 141 provided by the emitting element 140 enters the optical element 130, the light signal 141 may exit the optical element 130 through the characteristic pattern 170, so that the characteristic pattern 170 is shown or pin the eye 10 (i.e. projected to the eye). In a particular embodiment, the distance between one of the geometric shapes of the characteristic pattern 170 and the emitting element 140 is not exactly the same as the distance between another one of the geometric shapes of the characteristic pattern 170 and the emitting element 140. Therefore, the geometric shapes of the characteristic pattern 170 shown in the eye 10 which would be captured by the image capturing element 160 have energy differences (such as brightness differences), which is advantageous for identifying the position of the eye 10.

In some embodiments, the optical element 130 may include a coating layer 131. The coating layer 131 may be coated on the surfaces of the optical element 130, including but not limited to the front surface and the rear surface. In this embodiment, the characteristic pattern 170 is just the portion of the front surface (the side that is close to the eye 10) of the optical element 130 that is not coated with the coating layer 131. In some embodiments, after the coating layer 131 is coated on the whole optical element 130, the characteristic pattern 170 may be formed on the front surface of the optical element 130 by precision machining processes, such as micro/nano-cutting, high-precision grinding, high-precision polishing, and laser ablation. These precision machining processes may be advantageous for controlling the number, shapes, area, arrangement, and the like of the geometric shapes of the characteristic pattern 170. However, the characteristic pattern 170 may be formed on the optical element 130 by any suitable methods.

The visible light transmittance of the coating layer 131 may be between 90% and 100%. For example, the visible light transmittance of the coating layer 131 may be about 92%, about 95%, or about 98%, but is not limited thereto. As a result, after the visible light enters the optical element 130, most of the visible light may pass through the optical element 130, so that deficiency of brightness of the visible light is prevented and the disturbance to the user is reduced.

In addition, the light signal transmittance of the light signal 141 provided by the emitting element 140 transmitted through the coating layer 131 may be between 0% and 10%. For example, the light signal transmittance of the light signal 141 provided by the emitting element 140 transmitted through the coating layer 131 may be about 1%, about 2%, about 5%, or about 8%, but is not limited thereto. As a result, after the light signal 141 enters the optical element 130, most of the light signal 141 may first undergo reflection one or more times inside the optical element 130, then exit the optical element 130 through the characteristic pattern 170, and thus ensure that the characteristic pattern 141 could be shown in the eye 10 (i.e. brightness or energy is enough for being captured). Furthermore, to make sure that the light signal 141 could enter the optical element 130, the coating layer 131 would not be coated on the region of the optical element 130 that corresponds to the emitting element 140.

After the characteristic pattern 170 is shown in the eye 10, the image capturing element 160 may capture one or more images of the eye 10. The images of the eye 10 may be transmitted to a processing unit, such as an image processing unit including a visual processing chip. By processing and/or calculation, the position of the eye 10 (i.e. the eyeball) may be determined based on the characteristic pattern 170 in the eye 10. In a preferred embodiment, the processing unit is the image capturing element 160.

Furthermore, the optical element 130 includes a visible area 132 and a peripheral area 133. When the user watches the display screen, the eye 10 mainly corresponds to the visible area 132. That is, the visible area 132 is closer to the eye 10 than the peripheral area 133. In FIG. 1 and FIG. 2, the area of the visible area 132 is schematically illustrated with dashed lines. In some embodiments, to reduce possibilities that the user sees the characteristic pattern 170, the characteristic pattern 170 is formed in the peripheral area 133.

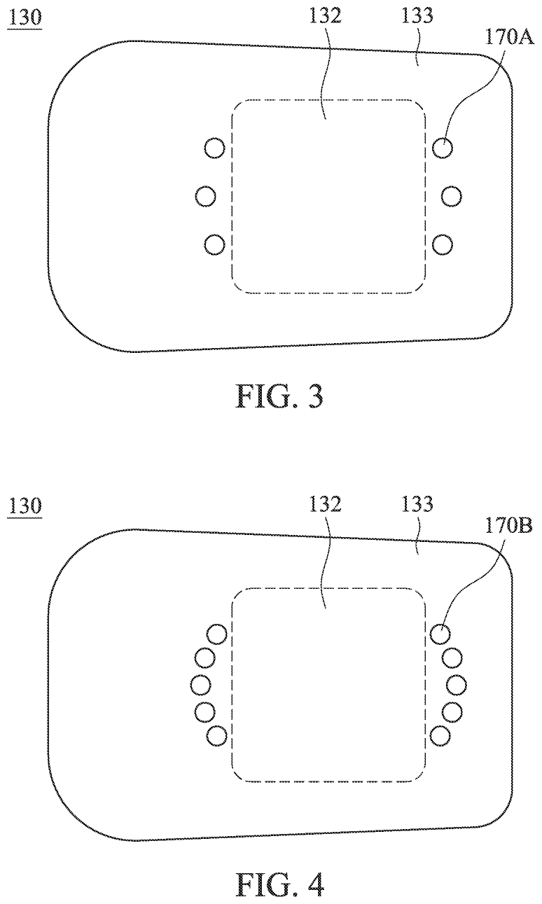

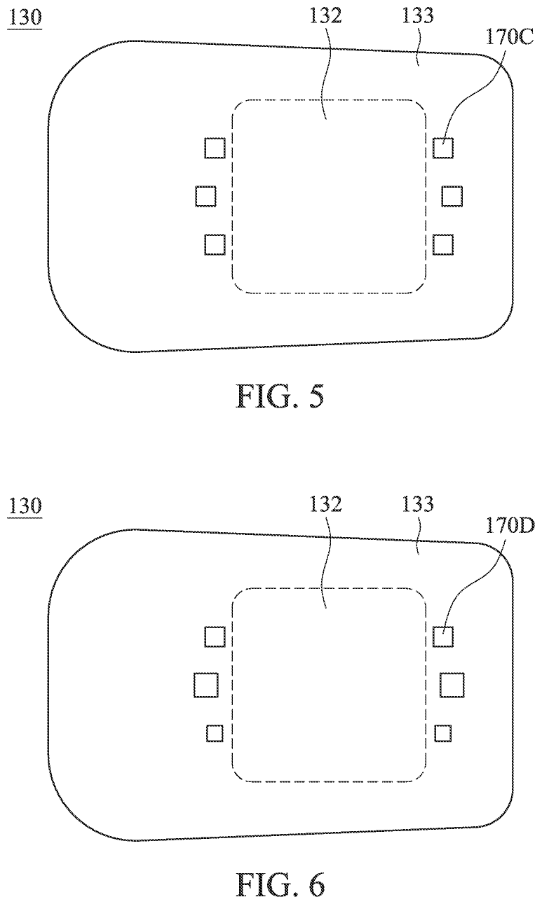

The number, shapes, area, arrangement, and the like of the geometric shapes of the characteristic pattern 170 are not limited to the embodiments illustrated in FIG. 1 and FIG. 2. Next, please refer to FIG. 3 to FIG. 6. FIG. 3 to FIG. 6 are schematic views of the optical element 130 with different characteristic patterns 170A, 170B, 170C, and 170D. As shown in FIG. 3, the characteristic pattern 170A includes six geometric shapes, and each geometric shape is a circle. As shown in FIG. 4, the characteristic pattern 170B includes ten geometric shapes, and each geometric shape is a circle. As shown in FIG. 5, the characteristic pattern 170C includes six geometric shapes, and each geometric shape is a rectangle. As shown in FIG. 6, the characteristic pattern 170D includes six geometric shapes, each geometric shape is a rectangle, and the geometric shapes do not have the same area.

When the number of the geometric shapes included in the characteristic pattern 170 is reduced, the cost may be reduced. When the number of the geometric shapes included in the characteristic pattern 170 is increased, the geometric shapes included in the characteristic pattern 170 have different shapes, or the geometric shapes included in the characteristic pattern 170 have different areas, the identification accuracy is enhanced. In other words, the characteristic pattern 170 is determined according to actual needs.

It should be noted that, for the traditional eye tracking methods, the characteristic pattern is generated by providing light directly to the eye via multiple emitting elements. For example, when the characteristic pattern includes ten geometric shapes, ten emitting elements are required for generating the characteristic pattern. In addition, for the traditional eye tracking methods, a reflective element with a relatively large volume may be required to reflect the characteristic pattern in the eye. As for the eye tracking device 100 of the present disclosure, the number of the emitting elements 140 may be reduced, and thus the cost may be reduced. In some embodiments, for a single eye 10, there may be only one emitting element 140. In addition, for the eye tracking device 100 of the present disclosure, a reflective element for reflecting the characteristic pattern in the eye is not required, and thus the volume of the eye tracking device 100 is reduced, thereby achieving miniaturization.

Furthermore, during the development and testing stage, when different characteristic patterns are tested, there is no need to adjust the emitting element 140 and the circuit element 150. In detail, only the optical element 130 with different characteristic patterns (such as characteristic patterns 170A, 170B, 170C, and 170D) needs to be replaced, and thus the cost is reduced and the process is simplified. However, for the traditional eye tracking devices, when different characteristic patterns are tested, the multiple emitting elements along with the circuit element should be replaced, so the cost is higher and the time spent is longer.

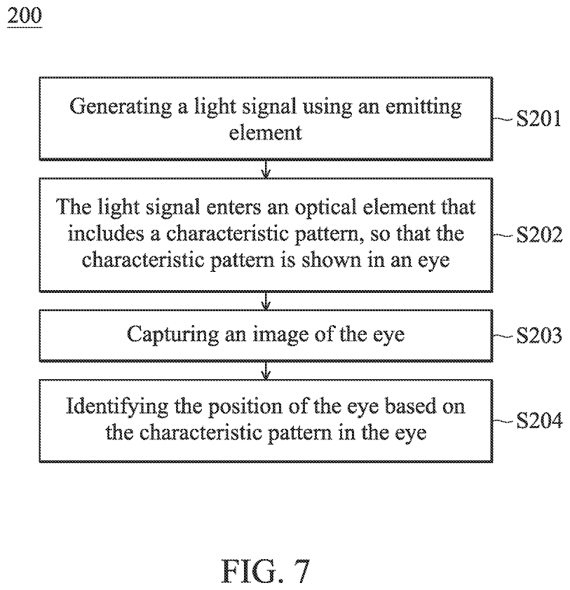

Next, please refer to FIG. 7. FIG. 7 is a flow chart of an eye tracking method 200. FIG. 7 is used to describe how the eye tracking device 100 is capable of tracking the eye. The eye tracking method 200 includes steps S201, S202, S203, and S204. In the step S201, a light signal is generated using an emitting element. For example, the emitting element 140 may generate the light signal 141, and the light signal may be an infrared light signal. In the step S202, the light signal enters an optical element that includes a characteristic pattern, so that the characteristic pattern is shown in an eye. For example, the light signal 141 may enter the optical element 130 that includes the characteristic pattern 170, and the energy of the light signal 141 exits the optical element 130 through the characteristic pattern 170 is strong enough, so that the characteristic pattern 170 may be shown in the eye 10. In the step 203, an image of the eye may be captured. For example, the image capturing element 160 may capture one or more images of the eye 10. In the step 204, the position of the eye is identified based on the characteristic pattern in the eye. For example, the images of the eye 10 may be transmitted to a processing unit, and the position of the eye 10 may be determined based on the processing and/or calculation. That is, the position or the focusing orientation of the eye may be tracked or determined by analyzing the positional relationship between the eye (eyeball) and the characteristic pattern in the images.

In a particular embodiment, in the captured image, if the horizontal position of the eye is located in the upper portion of the characteristic pattern, it means the user looks up. In a particular embodiment, in the captured image, if the horizontal position of the eye is located in the lower portion of the characteristic pattern, it means the user looks down. In a particular embodiment, in the captured image, if the eye is located among all the geometric shapes of the characteristic pattern, it means the user looks forward. In a particular embodiment, in the captured image, if the position of the eye is close to a side of the characteristic pattern, it means the user looks at the side.

The eye tracking device 100 and the eye tracking method 200 may have application in different fields. In some embodiments, the eye tracking device 100 and the eye tracking method 200 may be used for HMD. The HMD that is capable of tracking the eyes may make increase user interaction by displaying various images in response to the movement of the eye 10, and thus user experience is further enhanced. For example, the whole eye tracking device 100 may be placed on a side of the HMD that is close to the eye 10.

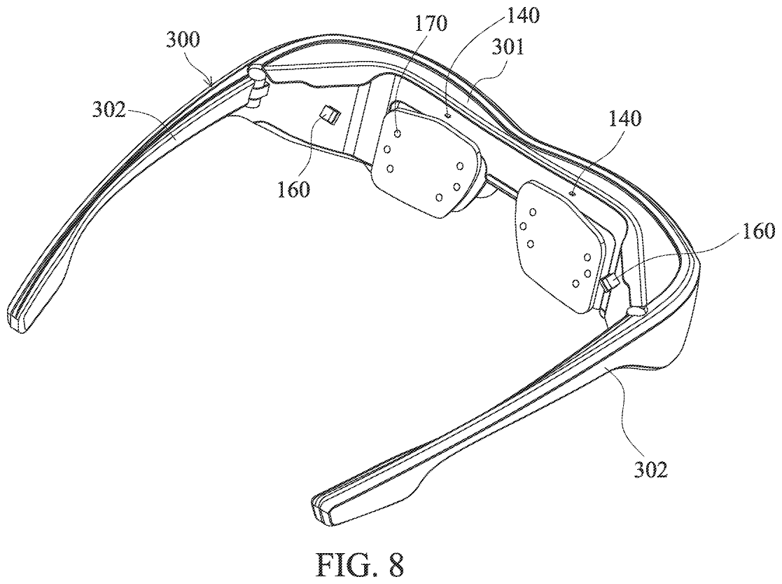

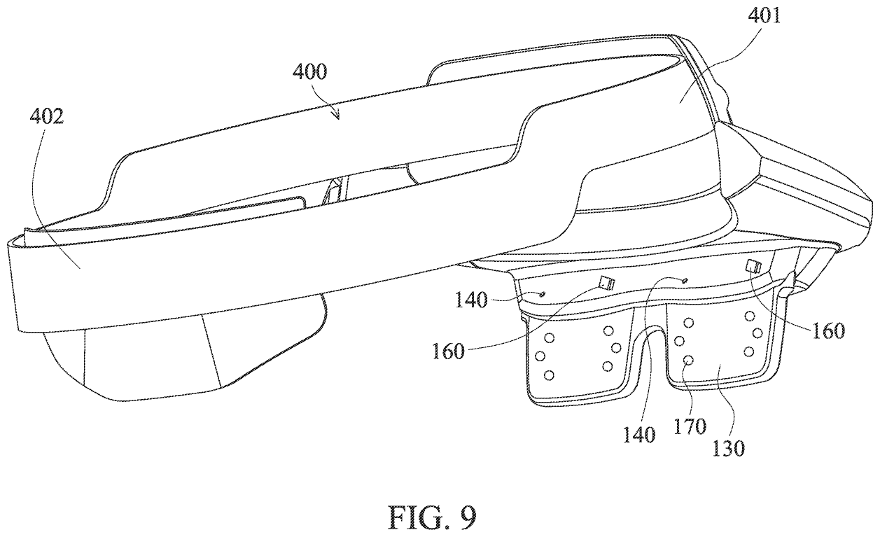

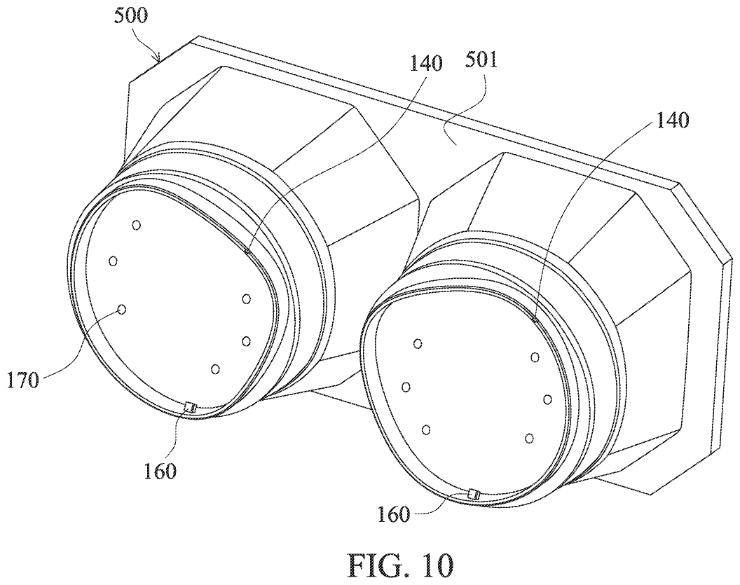

Next, please refer to FIG. 8 to FIG. 10. FIG. 8 to FIG. 10 are schematic views of the HMDs 300, 400, and 500 that are capable of tracking eyes, and they use the eye tracking method 200. The HMD 300 of FIG. 8 is a pair of glasses, including a body 301 and two arms 302 connected to the body 301. The HMD 400 of FIG. 9 is a helmet, including a main body 401 and a belt 402 connected to the main body 401. The HMD 500 of FIG. 10 is a pair of eye covers, including a housing 501.

The characteristic pattern 170 may be directly formed on the respective optical element of the HMDs 300, 400, and 500. The emitting element 140 may be disposed close to the respective optical element of the HMDs 300, 400, and 500. The image capturing element 160 may be disposed close to the eyes of the user. The HMD 300 is used as an example here, the emitting element 140 may be disposed on the body 301 of the HMD 300, and the image capturing element 160 may be disposed on the arms 302 of the HMD 300. However, the positions of the emitting element 140 and the image capturing element 160 are not limited to the embodiments illustrated in FIG. 8 to FIG. 10. As long as the light signal provided by the emitting element 140 is able to enter an optical element that includes the characteristic pattern 170, the characteristic pattern 170 is able to be shown in the eye, and the image capturing element 160 is able to capture the images of the eye, the circumstances are within the scope of the present disclosure.

As described above, based on the present disclosure, there is no need to generate the characteristic pattern by providing the light directly to the eye via multiple emitting elements. With fewer emitting elements, the characteristic pattern including a plurality of geometric shapes may be generated to reduce the number of the emitting elements required for the eye tracking device and the eye tracking method. Also, a reflective element for reflecting the characteristic pattern in the eye is not required, and thus miniaturization may be achieved. In addition, the number, shapes, area, arrangement, and the like of the geometric shapes of the characteristic pattern may be determined according to actual needs. Beside, during the development and testing stage, different characteristic patterns may be tested with lower cost and shorter time. Furthermore, the eye tracking device and eye tracking method of the present disclosure may be applied to different fields, including but not limited to HMDs.

The foregoing outlines features of several embodiments so that those skilled in the art may better understand the aspects of this disclosure. Those skilled in the art should appreciate that they may readily use this disclosure as a basis for designing or modifying other processes and structures for carrying out the same purposes and/or achieving the same advantages of the embodiments introduced herein. Those skilled in the art should also realize that such equivalent constructions do not depart from the spirit and scope of this disclosure, and that they may make various changes, substitutions, and alterations herein without departing from the spirit and scope of this disclosure. In addition, the scope of this disclosure is not limited to the specific embodiments described in the specification, and each claim constitutes a separate embodiment, and the combination of various claims and embodiments are within the scope of the disclosure.

1. An eye tracking device, comprising:
an optical element corresponding to an eye, wherein the optical element comprises a characteristic pattern;
an emitting element disposed close to the optical element, wherein the emitting element provides a light signal to the optical element, so that the characteristic pattern is shown in the eye; and
an image capturing element disposed close to the eye, wherein the image capturing element captures an image of the eye,
wherein the optical element further comprises a coating layer coated on a portion of a surface of the optical element, the characteristic pattern is the rest portion of the surface of the optical element that is not coated with the coating layer, a light signal transmittance of the coating layer for the light signal provided by the emitting element is between 0% and 10%, so that the light signal undergoes reflection one or more times inside the optical element before exiting the optical element through the characteristic pattern.

2. The eye tracking device as claimed in claim 1, further comprising a front cover and a back cover connected to the front cover.

3. The eye tracking device as claimed in claim 1, wherein the optical element comprises a visible area and a peripheral area, the visible area is closer to the eye than the peripheral area, and the characteristic pattern is formed in the peripheral area.

4. The eye tracking device as claimed in claim 1, wherein the light signal provided by the emitting element is an invisible light.

5. The eye tracking device as claimed in claim 1, wherein the light signal provided by the emitting element is an infrared light.

6. The eye tracking device as claimed in claim 1, wherein a visible light transmittance of the coating layer is between 90% and 100%.

7. (canceled)

8. The eye tracking device as claimed in claim 1, wherein the characteristic pattern comprises a plurality of geometric shapes.

9. (canceled)

10. The eye tracking device as claimed in claim 1, wherein the characteristic pattern is formed on the optical element by a precision machining process.

11. An eye tracking method, comprising:
generating a light signal using an emitting element, the light signal enters an optical element comprising a characteristic pattern, so that the characteristic pattern is shown in an eye;
capturing an image of the eye by an image capturing element; and
identifying a position of the eye based on the characteristic pattern in the eye by a processing unit or the image capturing element,
wherein the optical element further comprises a coating layer coated on a portion of a surface of the optical element, the characteristic pattern is the rest portion of the surface of the optical element that is not coated with the coating layer, a light signal transmittance of the coating layer for the light signal provided by the emitting element is between 0% and 10%, so that the light signal undergoes reflection one or more times inside the optical element before exiting the optical element through the characteristic pattern.

12. The eye tracking method as claimed in claim 11, wherein identifying the position of the eye comprises analyzing positional relationship between the eye and the characteristic pattern in the image.

13. The eye tracking method as claimed in claim 11, wherein the optical element comprises a visible area and a peripheral area, the visible area is closer to the eye than the peripheral area, and the characteristic pattern is formed in the peripheral area.

14. The eye tracking method as claimed in claim 11, wherein the light signal provided by the emitting element is an invisible light.

15. The eye tracking method as claimed in claim 11, the light signal provided by the emitting element is an infrared light.

16. The eye tracking method as claimed in claim 11, wherein a visible light transmittance of the coating layer is between 90% and 100%.

17. (canceled)

18. The eye tracking method as claimed in claim 11, wherein the characteristic pattern comprises a plurality of geometric shapes.

19. (canceled)

20. The eye tracking method as claimed in claim 11, the characteristic pattern is formed on the optical element by a precision machining process.
